(19) United States
(12) Patent Application Publication
(10) Pub. No.: US 2024/0188614 A1
(43) Pub. Date: Jun. 13, 2024

(54) COMPOSITION OF THE ENERGY DRINK AND A METHOD OF ITS MANUFACTURING

(71) Applicant: Mika Tapio REIJONEN, Helsinki (FI)

(72) Inventor: Mika Tapio REIJONEN, Helsinki (FI)

(21) Appl. No.: 18/286,554

(22) PCT Filed: Apr. 27, 2022
(86) PCT No.: PCT/FI2022/000004

§ 371 Date: Oct. 11, 2023

(30) Foreign Application Priority Data
Apr. 28, 2021 (FI) 20217079

(51) Int. Cl. A23L 27/00; A23L 2/02; A23L 2/39; A23L 2/40; A23L 2/54; A23L 2/56; A23L 2/60; A23L 2/66

(52) U.S. Cl. CPC A23L 27/86; A23L 2/02; A23L 2/39; A23L 2/40; A23L 2/54; A23L 2/56; A23L 2/60; A23L 2/66; A23L 27/84

(57) ABSTRACT

The invention relates to an energy drink composition and a method of its manufacturing. The bitterness of the energy drink (6) is reduced by using a basic magnesium compound (2), which is added to the energy drink ingredients (1) and water (3) and heated (4), and it is added flavor, color and preservation substances or pasteurized (5).

### FIELD OF THE INVENTION

A target of the invention is energy drinks. The typical ingredients in energy drinks are caffeine, taurine and/or BCAA branched chain amino acids, leucine, isoleucine and valine, sugars and/or artificial sweeteners and B vitamins.

### BACKGROUND OF THE INVENTION

A lot of sugar and/or artificial sweeteners have to be used to mask the bitter taste of energy drinks.

Much work has been done in order to solving of the bitterness of energy drinks. It is difficult to mask the bitter taste, as described in Masking Bitter Taste by Molecules, Jakob P. Ley, Chemosensory Perception volume 1, pages 58-77 (2008) “Combating bitter taste in food, pharmaceuticals, and beverages remains a huge challenge”.

One way is to use artificial sweeteners. Artificial sweeteners are not considered to taste good by many, and their harmfulness has been discussed. Thus, a lot of work has been done on how to solve the problems, as in EP18174277, Composition, Red Bull GmbH, which aimed to get artificial sweeteners towards the taste of natural sugar, and there tannin was used as one part.

### OBJECT OF THE INVENTION

The object of the invention is to reduce the bitterness of energy drinks without using a lot of sugars and/or sweeteners.

### DESCRIPTION OF THE INVENTION

The invention is characterized by what is presented in the characterizing part of the claim 1. The energy drink will be added a lot of sugar and/or artificial sweeteners to remove bitterness is characterized in that the main ingredients in the energy drink, caffeine, taurine and/or branched chain amino acids BCAA amino acids, leucine, isoleucine and valine, sugar and/or artificial sweetener and B vitamins heated in water solution while using a sufficient amount of basic magnesium compound to reduce the bitterness of the energy drink, allowing the amount of sugar and/or artificial sweetener in the energy drink to be reduced.

Energy drinks are bitter, so a lot of sugar and/or artificial sweeteners have to be added to remove the bitterness. The invention uses a basic magnesium compound, typically magnesium hydroxide or magnesium oxide and heat, typically 60 to 100 degrees Celsius and a time of 1 minute to 10 hours with stirring at normal atmospheric pressure. So, the amount of sugar and/or artificial sweetener in the energy drink can be reduced.

Current energy drinks are usually very acidic. Acidity can also come to an energy drink, for example, by an added juice. After water, the second most consumed drink in the world is tea, its pH is usually 5.5. That pH is good, does not cause tooth erosion and does not interfere with gastric pH, this is the same thing in this invention, the pH is typically 5.5-8.0. The erosion of teeth begins, when the pH of the beverage is below 5.5.

The effect of caffeine is based on the stimulation of the central nervous system, which increases the state of alertness and well-being and decreases the feeling of fatigue. Caffeine can be synthetically produced or of natural origin. Energy drinks use, for example, tea extract or guarana as a source of caffeine, which contain substances other than caffeine. Caffeine and taurine are used together because it has been shown to provide a combined effect to improve performance.

The brain uses sugar for its energy, and its intake is important, but the amounts of sugar in energy drinks are unhealthy. Sugar gives also pleasure. Artificial sweeteners lack energy and their taste is not liked by many, and their health has been discussed.

Fruit and berry juices can be added to energy drinks, these taste good and sugar comes with them. There are many artificial flavors and there are also colors of both an artificial and natural origin.

Energy drinks can be concentrates to which water is added at home and the carbonation can be done also at home.

The energy drink powder can be made into an energy drink according to the invention, for example by spray drying. Water is added to the energy drink powder and possibly carbonated or the energy drink powder is made into an effervescent tablet.

Preservatives are added to energy drinks or the energy drink is pasteurized. There are a variety of preservatives, some in acidic and some in neutral environment. Many energy drinks are carbonated and these can be more or less carbonated.

### BRIEF DESCRIPTION OF THE FIGURES

### Figures

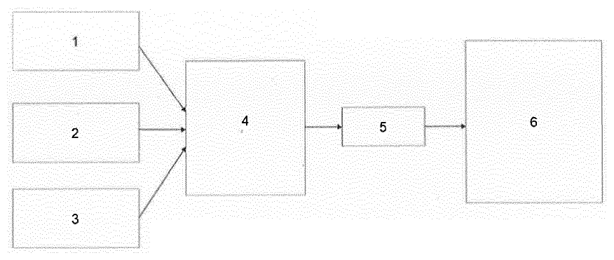

FIG. 1 is a schematic diagram of the composition of an energy drink and a method of making the same. The typical ingredients of an energy drink (1), a basic magnesium compound (2) and water (3) are mixed and heated (4), flavorings, colorings and preservatives are added or pasteurized (5) to obtain an energy drink (6).

### DETAILED DESCRIPTION OF PREFERRED EMBODIMENTS

I did a lot of experiments with different substances to reduce the bitterness of the energy drink. For example, in EP0582396, a Taste-masking composition of bitter pharmaceutical agents, Pfizer Inc. uses magnesium oxide to mask the bitter taste of the antibiotic. I added magnesium oxide to the finished energy drink, but it did not work the way I wanted it to. Surprisingly, when the energy drink was heated with magnesium oxide, and the resulting solution was tasted, it was too sweet. At that time, the invention was born, and in addition, the nH of the new energy drink had risen.

The basic magnesium compound, typically magnesium hydroxide or magnesium oxide, reacts with heat with the components of a typical energy drink, which are typically caffeine, amino acids, taurine and/or BCAA branched chain amino acids, leucine, isoleucine and valines, sugars and vitamin B. Amino acids are resistant to heating and many substances can be added to energy drinks, such as various vitamins, and it is clear that if heat-sensitive substances are added, they are added after the use of heat.

### EXAMPLES

### Example 1

The composition of the energy drink and the method of its manufacturing
water 100 ml
caffeine 32 mg
taurine 400 mg
magnesium hydroxide 120 mg, contains 50 mg of magnesium
sucrose 2 g
glucose 0.5 g
glucuronolactone 200 mg
vitamin B2 0.7 mg
vitamin B3 8.5 mg
vitamin B6 0.8 mg
vitamin B12 2.5 μg
ethyl-p-hydroxybenzoate 50 mg
strawberry flavor 0.05 g making a batch of 10,000 liters, stirring and heating at 80 degrees Celsius for 20 minutes at normal atmospheric pressure.

### Example 2

The composition of the energy drink and the method of its manufacturing
water 100 ml
caffeine 32 mg
taurine 400 mg
magnesium hydroxide 120 mg, contains 50 mg of magnesium
sucrose 2 g
glucose 0.5 g
glucuronolactone 200 mg
vitamin B2 0.7 mg
vitamin B3 8.5 mg
vitamin B6 0.8 mg
vitamin B12 2.5 μg
ethyl-p-hydroxybenzoate 50 mg
strawberry flavor 0.05 g
making a batch of 10 000 liters, stirring and heating at 80° C. for 20 minutes at normal atmospheric pressure and carbonating to 5 g/l.

### Example 3

The composition of the energy drink and the method of its manufacturing
water 100 ml
caffeine 32 mg
taurine 400 mg
magnesium hydroxide 120 mg, contains 50 mg of magnesium
sucrose 2 g
glucose 0.5 g
glucuronolactone 200 mg
vitamin B2 0.7 mg
vitamin B3 8.5 mg
vitamin B6 0.8 mg
vitamin B12 2.5 μg
strawberry flavor 0.05 g
making a batch of 10,000 liters, stirring and heating at 80 degrees Celsius for 20 minutes at normal atmospheric pressure and pasteurization.

### Example 4

The composition of the energy drink and the method of its manufacturing
water 100 ml
caffeine 32 mg
taurine 400 mg
magnesium hydroxide 120 mg, contains 50 mg of magnesium
sucrose 2 g
glucose 0.5 g
glucuronolactone 200 mg
vitamin B2 0.7 mg
vitamin B3 8.5 mg
vitamin B6 0.8 mg
vitamin B12 2.5 μg
strawberry flavor 0.05 g
making a batch of 10 000 liters, stirring and heating at 80° C. for 20 minutes under normal atmospheric pressure, pasteurization and carbonation to 5 g/l.

### Example 5

The composition of the energy drink and the method of its manufacturing
water 100 ml
caffeine 32 mg
taurine 400 mg
magnesium hydroxide 120 mg, contains 50 mg of magnesium
sucrose 0.5 g
aspartame 5 mg
vitamin B2 0.7 mg
vitamin B3 8.5 mg
vitamin B6 0.8 mg
vitamin B12 2.5 μg
ethyl-p-hydroxybenzoate 50 mg
strawberry flavor 0.05 g
making a batch of 10,000 liters, stirring and heating at 80 degrees Celsius for 20 minutes at normal atmospheric pressure.

### Example 6

The composition of the energy drink and the method of its manufacturing
water 100 ml
caffeine 32 mg
taurine 400 mg
magnesium hydroxide 120 mg, contains 50 mg of magnesium
sucrose 0.5 g
aspartame 5 mg
vitamin B2 0.7 mg
vitamin B3 8.5 mg
vitamin B6 0.8 mg
vitamin B12 2.5 μg
ethyl-p-hydroxybenzoate 50 mg
strawberry flavor 0.05 g
making a batch of 10 000 liters, stirring and heating at 80° C. for 20 minutes at normal

### Example 7

The composition of the energy drink and the method of its manufacturing
water 100 ml
caffeine 32 mg
taurine 400 mg
magnesium hydroxide 120 mg, contains 50 mg of magnesium
sucrose 0.5 g
aspartame 5 mg
vitamin B2 0.7 mg
vitamin B3 8.5 mg
vitamin B6 0.8 mg
vitamin B12 2.5 μg
strawberry flavor 0.05 g
making a batch of 10,000 liters, stirring and heating at 80 degrees Celsius for 20 minutes at normal atmospheric pressure and pasteurization.

### Example 8

The composition of the energy drink and the method of its manufacturing
water 100 ml
caffeine 32 mg
taurine 400 mg
magnesium hydroxide 120 mg, contains 50 mg of magnesium
sucrose 0.5 g
aspartame 5 mg
vitamin B2 0.7 mg
vitamin B3 8.5 mg
vitamin B6 0.8 mg
vitamin B12 2.5 μg
strawberry flavor 0.05 g
making a batch of 10 000 liters, stirring and heating at 80° ° C. for 20 minutes under normal atmospheric pressure, pasteurization and carbonation to 5 g/l.

### Example 9

The composition of the energy drink and the method of its manufacturing
water 100 ml
caffeine 32 mg
taurine 400 mg
magnesium hydroxide 120 mg, contains 50 mg of magnesium
aspartame 6 mg
vitamin B2 0.7 mg
vitamin B3 8.5 mg
vitamin B6 0.8 mg
vitamin B12 2.5 μg
ethyl-p-hydroxybenzoate 50 mg
strawberry flavor 0.05 g
making a batch of 10,000 liters, stirring and heating at 80 degrees Celsius for 20 minutes at normal atmospheric pressure.

### Example 10

The composition of the energy drink and the method of its manufacturing
water 100 ml
caffeine 32 mg
taurine 400 mg
magnesium hydroxide 120 mg, contains 50 mg of magnesium
aspartame 6 mg
vitamin B2 0.7 mg
vitamin B3 8.5 mg
vitamin B6 0.8 mg
vitamin B12 2.5 μg
ethyl-p-hydroxybenzoate 50 mg
strawberry flavor 0.05 g
making a batch of 10 000 liters, stirring and heating at 80° C. for 20 minutes at normal atmospheric pressure and carbonation to 5 g/l.

### Example 11

The composition of the energy drink and the method of its manufacturing
water 100 ml
caffeine 32 mg
taurine 400 mg
magnesium hydroxide 120 mg, contains 50 mg of magnesium
aspartame 6 mg
vitamin B2 0.7 mg
vitamin B3 8.5 mg
vitamin B6 0.8 mg
vitamin B12 2.5 μg
strawberry flavor 0.05 g
making a batch of 10,000 liters, stirring and heating at 80 degrees Celsius for 20 minutes at normal atmospheric pressure and pasteurization.

### Example 12

The composition of the energy drink and the method of its manufacturing
water 100 ml
caffeine 32 mg
taurine 400 mg
magnesium hydroxide 120 mg, contains 50 mg of magnesium
aspartame 6 mg
vitamin B2 0.7 mg
vitamin B3 8.5 mg
vitamin B6 0.8 mg
vitamin B12 2.5 μg
strawberry flavor 0.05 g
making a batch of 10 000 liters, stirring and heating at 80° C. for 20 minutes under normal atmospheric pressure, pasteurization and carbonation to 5 g/l.

### Example 13

The composition of the energy drink and the method of its manufacturing
water 100 ml
caffeine 32 mg
taurine 200 mg
leucine 500 mg
isoleucine 125 mg
valine 125 mg
magnesium hydroxide 120 mg, contains 50 mg of magnesium
sucrose 2 g
glucose 0.5 g
glucuronolactone 200 mg
vitamin B2 0.7 mg
vitamin B3 8.5 mg
vitamin B6 0.8 mg
vitamin B12 2.5 μg
strawberry flavor 0.05 g
making a batch of 10,000 liters, stirring and heating at 80 degrees Celsius for 20 minutes at normal atmospheric pressure and pasteurization.

### Example 14

The composition of the energy drink and the method of its manufacturing
water 100 ml
caffeine 32 mg
leucine 1000 mg
isoleucine 250 mg
valine 250 mg
magnesium hydroxide 120 mg, contains 50 mg of magnesium
sucrose 2 g
glucose 0.5 g
glucuronolactone 200 mg
vitamin B2 0.7 mg
vitamin B3 8.5 mg
vitamin B6 0.8 mg
vitamin B12 2.5 μg
strawberry flavor 0.05 g
making a batch of 10,000 liters, stirring and heating at 80 degrees Celsius for 20 minutes at normal atmospheric pressure and pasteurization.

### Example 15

The composition of the energy drink and the method of its manufacturing
water 100 ml
caffeine 32 mg
taurine 400 mg
magnesium hydroxide 120 mg, contains 50 mg of magnesium
stirring and heating at 80° C. for 20 minutes at normal atmospheric pressure, then adding at
room temperature with stirring
sucrose 2 g
glucose 0.5 g
glucuronolactone 200 mg
vitamin B2 0.7 mg
vitamin B3 8.5 mg
vitamin B6 0.8 mg
vitamin B12 2.5 μg
ethyl-p-hydroxybenzoate 50 mg
strawberry flavor 0.05 g

It is obvious to those skilled in the art that the invention is not limited to the details of the above embodiments. It will be apparent to one skilled in the art that natural sugars such as sucrose, glucose, fructose or mixtures thereof and syrups may be added to the energy drink. Natural sugars may be replaced in whole or in part by artificial sweeteners such as sucralose, aspartame or acesulfame potassium. Steviol glycosides extracted from the leaves of the stevia plant can also be used as a sweetener.

Various vitamins can be added to the energy drink, such as vitamins B, C and E, or vitamin-like substances such as inositol and choline.

Various minerals such as zinc, calcium, magnesium, sodium, selenium and potassium can be added to an energy drink.

Various juices can be added to the energy drink, such as peach juice and various extracts, ginseng, guarana, Ginkgo biloba, yerba mate and tea extracts.

Acids such as malic, citric and hyaluronic acids can be added to the energy drink.

Glucuronolactone can be added to an energy drink.

Alcohol can be added to the energy drink.

Flavoring substances, for example strawberry flavoring, can be added to the energy drink.

Colorants, such as lycopene, may be added to the energy drink.

Collagen can be added to an energy drink.

Amino acids can be added to the energy drink, for example L-leucine and/or L-valine and/or L-isoleucine and/or L-carnitine and/or L-theanine.

The energy drink may be pasteurized and/or a preservative may be used, for example ethyl-p-hydroxybenzoate.

The energy drink can be carbonated.

The energy drink is made by adding non heat resistant substances after using the heat.

According changing rules and a new PCT rule 1 Jul. 2010 46.5, 66.8, 72.2 (c-bis) there is presented paragraphs where the changes are in this priority application FI20217079.

In the intermediate decision of this priority application FI20217079, by the Finnish Patent and Registration Office, it was presented the next four reference publications.

In the US 20070154614 A1 Protein beverage and method of making the same, where it is presented a protein beverage and all examples include proteins.

In the WO 2019246395 A1 Methods and compositions for reducing caffeine side effects, where it is presented caffeinated energy drinks, in which it is used magnesium citrate, magnesium citrate is acidic.

In the JP 2003128664 A Polyphenol salt, food product and beverage, and method for reducing acerbity, bitterness or astringency of polyphenol or extract containing polyphenol, where it is presented making a polyphenol salt after e.g. extraction of the tea leaves.

In the U.S. Pat. No. 6,403,129 B1 Carbonated fortified milk-based beverage and method of making carbonated fortified milk-based beverage for the supplementation of essential nutrients in the human diet, where it is presented protein based beverages.

1. The energy drink will be added a lot of sugar and/or artificial sweeteners to remove bitterness is characterized in that typical ingredients in the energy drink, such caffeine, taurine or/and branched chain amino acids BCAA, leucine, isoleucine and valine, sugar and/or artificial sweetener and vitamins B, (1) by heating (4) in the water solution (3) using in the same time the enough amount of alkaline magnesium compound (2) reducing the bitterness of the energy drink (6), and then it can be reduce the amount of sugar and/or artificial sweetening in the energy drink (6).

2. Energy drink according to claim 1, characterized in that the magnesium compound (2) is magnesium hydroxide Mg(OH)₂ or is formed into magnesium hydroxide Mg(OH)₂ for example, magnesium oxide MgO can be used to convert magnesium hydroxide, the amount of magnesium is typically 400-1000 mg/l.

3. Energy drink according to claim 1, characterized in that the heating (4) is typically 60 to 100 degrees Celsius and the time is 1 minute to 10 hours and at normal atmospheric pressure.

4. Energy drink according to claim 1, characterized in that the pH is typically 5.0 to 8.0, for example 5.5.

5. Energy drink according to claim 1, characterized in that the energy drink (6) obtained contains 0.5 to 5.0 g/100 ml, typically sucrose and/or glucose.

6. Energy drink according to claim 1, characterized in that the energy drink (6) obtained contains artificial sweeteners and/or steviol glycosides.

7. Energy drink according to claim 1, characterized in that the energy drink (6) obtained contains 100 to 500 mg/l of caffeine.

8. Energy drink according to claim 1, characterized in that the energy drink (6) obtained contains from 250 to 4000 mg/l of taurine and from 2000 to 40,000 mg/l of the branched-chain amino acids BCAA leucine, isoleucine and valine.

9. Energy drink according to claim 1, characterized in that the energy drink (6) can be made into a concentrate to which water is added and, if desired, carbonated, the energy drink (6) can be made for example by spray drying energy drink powder, which can be made also an energy drink effervescent tablet.

10. Energy drink according to claim 1, characterized in that the energy drink (6) contains amino acids, for example berry and/or fruit juice and/or B vitamins and/or vitamin C and/or vitamin E and/or inositol and/or choline and/or glucuronolactone and/or guarana and/or Ginkgo biloba extract and/or yerba mate extract and/or tea extract and/or collagen extract and/or collagen and/or calcium and/or magnesium and/or selenium, and/or sodium and/or potassium and/or zinc, flavorings, for example strawberry flavoring, alcohol or no alcohol, preservative, for example ethyl-p-hydroxybenzoate and/or the energy drink is pasteurized (5), and the energy drink (6) is non-carbonated or carbonated.
